(19) United States
(12) Patent Application Publication
(10) Pub. No.: US 2017/0018200 A1
(43) Pub. Date: Jan. 19, 2017

(54) METHOD AND SYSTEM FOR VIRTUAL INTERACTIVE MULTIPLAYER LEARNING

(71) Applicants: Ruth Nemire, Plantation, FL (US); Lucinda l. Maine, Arlington, VA (US); Scott M. Martin, Fairfax Station, VA (US)

(72) Inventors: Ruth Nemire, Plantation, FL (US); Lucinda l. Maine, Arlington, VA (US); Scott M. Martin, Fairfax Station, VA (US)

(21) Appl. No.: 14/591,646

(22) Filed: Jan. 7, 2015

(51) Int. Cl. G09B 5/10; A63F 13/79; A63F 13/655; G09B 7/02; A63F 13/822; A63F 13/847; A63F 13/28; G09B 5/06; A63F 13/352; A63F 13/215

(52) U.S. Cl. CPC G09B 5/10; A63F 13/352; A63F 13/79; A63F 13/655; A63F 13/215; A63F 13/822; A63F 13/847; A63F 13/28; G09B 5/065; G09B 7/02

(57) ABSTRACT

A virtual interactive multiplayer platform and method of use is provided. In a preferred embodiment, the general steps of the method herein are: downloading scenario software, determining, a scenario and activating it, generating a quest scenario, entry of the system by a number of players, selecting a team for each entered player, entry of each player into the quest scenario itself, running the virtual interactive quest scenario, collecting data regarding player and team interaction and performance, and assessing team and player performance. The interactive multiplayer platform places each player in the role of a team member working with other virtual team members to manage and solve simulated situations. The virtual interactive multiplayer platform can be used for a number of training and educational purposes such as, e.g., for the medical car health professions, corporate members, the military or diplomatic corps or other arms of government, and K-12 teachers or students.

### TECHNICAL FIELD OF THE INVENTION

The present invention relates to the field of game training and education.

### BACKGROUND OF THE INVENTION

Before the creation of the internet and our increasingly mobile economy, the expectation of education was that it would be limited in time and place, to wherever traditional classrooms and classes could be provided by educators and attended by students. However, the modern student learner expects more. The expectation is, increasingly, that, access to information and opportunities for learning will be provided at increasingly flexible times and in new settings, including accessibility from the student's home. Because of these expectations, new models for education, must be student-centered and change the learning experience. Students expect to be engaged actively in learning. When students are not engaged. they may not learn the material needed to be successful in a course and ultimately in practice of their chosen profession.

One professional area where this has become particularly true, due to the nature of the profession, is in the health and medical professions. Professionals in these fields are often under extreme pressure, limiting the amount of time, and the availability of hours, they can devote to traveling to seminars and the like or to traditional classroom studies and courses.

An additional challenge in these fields is that a number of different health, and medical professionals often need to work with each, across professions in an inter-professional manner, other to provide good health and medical care to patients to improve outcomes. Health professions education leaders and faculty have been tasked by the institute of Medicine and various educational accreditation bodies to incorporate inter-professional education into curricula.

Yet despite this rising expectation, education far the individual health and medical professions tends to be somewhat isolated. Often, schools that oiler education in, for example, dentistry, pharmacy, nursing, medicine and other specialties will not exist, within a given university or college, on the same campus or even in the same city. Even where the differing schools are on the same campus, they can be very isolated from each other, severely limiting inter-professional educational opportunities. In addition, students, learners and faculty are often away from campus for various reasons and sometimes not even in the same country.

Some of these issues have begun to be addressed by training simulation exercises, in which students are all working from the same materials and online classes that allow at least some portability of learning. However, little progress has been made in creating educational experiences a id scenarios that allow students within differing professional training programs to work and learn in an inter-professional way, wherein each student enhances skills needed for their own specialty while learning to collaborate and integrate with other students inter-professionally. One obstacle to creating such a simulation or educational opportunity has been the question of assessment. Accreditors, faculty and students need to see concrete evidence of student learning within each educational experience and students need to have feedback regarding communications, problem solving, and interpersonal skills required to practice in a team.

There have been a number of consequences to the relative isolation of health care professional education and training. When students are not trained together in the health care industry, yet are routinely expected to work together, the education and training fails to match real-world parameters, This can result in a breakdown in the understanding of roles of other professionals and breakdowns in communication, leading to reduced quality care and increased patient safety issues.

Students who do not have the opportunity to interact in a team environment during their education may, when they enter the workplace or practice, not able to meet the needs of employers or effectively function as a team member. Also, it is difficult for students who do not receive feedback about performing in collaborative and inter-professional settings to improve, let alone, master, working in such settings. Students who do not receive feedback about interacting in team situations may not understand best way of communication within a team, the role of the other professional, their own role, or team dynamics. It is not difficult to see how this can lead to errors that affect quality or safety of a product or practice environment, or creates an unsafe environment for the patient needing care.

Further, it is import it to create opportunities an exercises. particularly collaborative ones, showing students that science, technology, engineering and math education can be collaborative and exciting. One of the consequences at failing to do so has been, and will continue to be, a reduction of the STEM professionals that graduate from US schools and colleges. Not surprisingly, providing means to enable inter-professional education of professions students has been shown to increase student interest and improve the quality and safety of health care.

Attempts have, accordingly, been mad e to update learning and educational methods past the traditional classroom paradigm. There are, for example, some virtual simulations for health professions students or licensed health care providers that are individually based and rely on an individual player to interact with the computer to make decisions. Immediate feedback to the student may or may be included, but stealth assessment, benchmarking and feedback to faculty is typically not a part of these games, greatly limiting their usefulness for formal education.

There are also simulations that use simulated patients, or even people acting as a “patient” for the exercise, wherein scenarios are run to help educate professionals. Occasionally, a day or two in a semester or year ma be used to bring students from various professions together to practice a simulation. However, scheduling between different types of exercises, not to mention setting up separate and running multiple-profession scenarios, is cumbersome and cost prohibitive for some educational systems. These patient simulations typically require that faculty create scenarios, hire actors to play patient roles, pay the actors, and use multiple faculty for evaluation and feedback. The simulations are usually limited by time and place and budgets, and can be a large drain on resources. Further, learning about other professions and their expectations and challenges, even within these training scenarios, is typically not given priority due to all of the other curricular requirements. Feedback and assessment in programs tends to still be used on each student's knowledge of their own specialty, giving them little incentive to focus on team or inter-professional competencies.

Some health professions schools (e.g., medicine, nursing, dental) may have simulation labs with models that are able simulate events such as giving birth or treating a cardiac event. Interactions in these labs may involve individual professional students, or inter-professional teams. However, such simulation laboratories and simulation mannequins are often cost prohibitive for many schools. The size of the lab and the type of mannequin an advanced simulation requires, laboratories equipped for use by multiple students particularly for inter-professional education involving multiple types of students and scenarios, can cost millions of dollars to build and even more to provide the human capital to operate the lab and equipment. Overall, these labs are cumbersome and expensive to equip, and learning opportunities are not consistent or easily scheduled. They are usually not available to a large number of those obtaining a health professions education, and rarely, if ever, to undergraduate students. These types of simulations are also typically not available in education outside a college or university program, such as K-12 environments or in professional working environments

Neither classroom nor laboratory simulations nor scenarios, despite their high cost and time involvement, fully meet the need of enabling all students in professions to practice inter-professionally and to learn about different roles or real team interactions because of the limitation of time and space.

Meanwhile, the currently available online games and simulations are primarily designed for single player activities and education. Accordingly, little has been done towards providing an educational experience that will provide adequate inter-professional interactive opportunities with sufficient and appropriate feedback for student understanding and improvement.

### SUMMARY

A virtual, interactive multiplayer platform “virtual platform” is provided. The virtual platform is generally configured, and compiled and parsed by a server or servers.

In one preferred embodiment, at least one administrator, using at least one server or other suitable electronic device, uploads at least one pre-designed and programmed scenario through a scenario builder interface. The system administrator information is received by the resource manager. Then the resource manager populates guest and player profile for each s uploaded. One or more players, enter the virtual platform.

The players ay to into the virtual platform using personal or centralized electronic devices, via individualized interfaces and through a player profile The interactive player profile interface accepts information from each player, which the player inputs as will be shown herein. From the player profile, players are assigned by at, least on cloud based algorithm to begin a quest.

A number of specific quests or challenges that players can choose, or be assigned, and embark upon are created through the scenario builder interface. As with the number of players, the number of actual scenarios or quests can be virtually any number the virtual platform and underlying server system can support.

The players register and then log in through the player profile interface. At the player profile interface, players create a virtual avatar for themselves and accept a role within the virtual platform. The role and avatar can also be assigned by another part such as an instructor or administrator. The player can be given the option of choosing a level of play, such as, e.g., easy, medium, or difficult. Depending on the type of game being played, a level may be assigned by system administrator.

Upon entering the virtual platform, each player choose or be assigned a quest. The players can be assigned to a team by the cloud based server, administrator, choose a team for themselves or choose to interact with a pre-designed and programmed simulated team provided to the players by the cloud based server. Assignments can he made according to player inter profession, grade level, need for continuing professional development and/or other pre-determined factors.

The virtual, platform, challenges and possible scenarios based upon possible player actions are loaded into the quests in he scenario library database. Information from this database is loaded into the quests to increase their accuracy, while information from the quests is downloaded into the scenario library database to increase its available information about game play and scenarios from player interaction.

Within each individual quest, the player or team of players faces a specific pre-programmed scenario. The scenario in this embodiment simulates a health situation or emergency calling for inter-professional action and/or treatment. For example, situations from a single complicated patient situation to the wreck of a plane, can be simulated upon which a group of professionals would be expected to interact to respond to this quest challenge, each bringing his or her specialized education or skills. The players would also be expected to work as a team to resolve the situation and treat any patient(s).

Information about player performance and decisions is tracked routinely from the quests by the cloud based server usually while in progress, to a stealth assessment and analysis algorithm. This information can be further transferred through the database and stored in user database where it may be used to modify or change, based upon pre-determined directions, the quest the player is involved in. The data retrieved from the stealth assessment and analysis interface can measure player competency at such matters as information retention, informal learning, inter-professional education, communication, ethics or other chosen factors, outcomes, lessons and reflection activities, and apply this information to resources given to the players. Players who do not engage in good team work, or who seek advantage by maneuvering or outright cheating will be provided with negative feedback to the stealth assessment and analysis interface and rather than profit from this lack of teamwork and/or ethics, will face reduced resources and a concurrently lowered assessment.

Information about the operation and performance of the players through the quests can be collected by a user database. By this arrangement, feedback can be collected from the quests and provided to the player database and to individual players and to the quest administrator. Conversely, information about a player from the player profile interface can be transmitted, through the player database and cloud based servers to make decisions such as team and resource allocation for the players.

The information can be distributed via at least one server, in this embodiment one or more cloud servers or other real time data storage and dissemination systems known in the art to provide instant feedback to players or other parties on their learning accomplishments.

In a preferred embodiment, the general steps of the method herein are downloading scenario software, determining a scenario and activating it, generating a quest scenario, entry of the system by each player, selecting a team for each entered player, entry of each player into the quest scenario itself, running the virtual interactive quest scenario, collecting data regarding player and team interaction and performance, and assessing team and player performance.

Use of the virtual platform is by no means limited to the medical or health professions. In other embodiments, for a few examples, the virtual platform can be used to provide training for corporate members, the military or diplomatic corps or other arms of government, and K-12 teachers or students.

### BRIEF DESCRIPTION OF THE DRAWINGS

FIG. 1 is a schematic diagram featuring an embodiment of the present invention.

FIG. 2 is a schematic diagram featuring aspects of the embodiment of FIG. 1.

FIG. 2A is a schematic diagram providing further illustration of an aspect shown in FIG. 2.

FIG. 3 is a diagram of a representative data entry interface of the embodiment of FIG. 1.

FIG. 4 is a diagram of a representative data entry interface of the embodiment of FIG. 1.

FIG. 5 is a schematic diagram featuring primary steps of an embodiment of the method of the present invention.

FIG. 6 is a schematic diagram featuring an embodiment of the present invention.

### DETAILED DESCRIPTION OF PREFERRED EMBODIMENTS

Other objects, features, and advantages of the invention will become apparent from a consideration of the following detailed description and the accompanying drawings. The following descriptions are made referring to the figure, wherein like reference numbers refer to like features throughout this description.

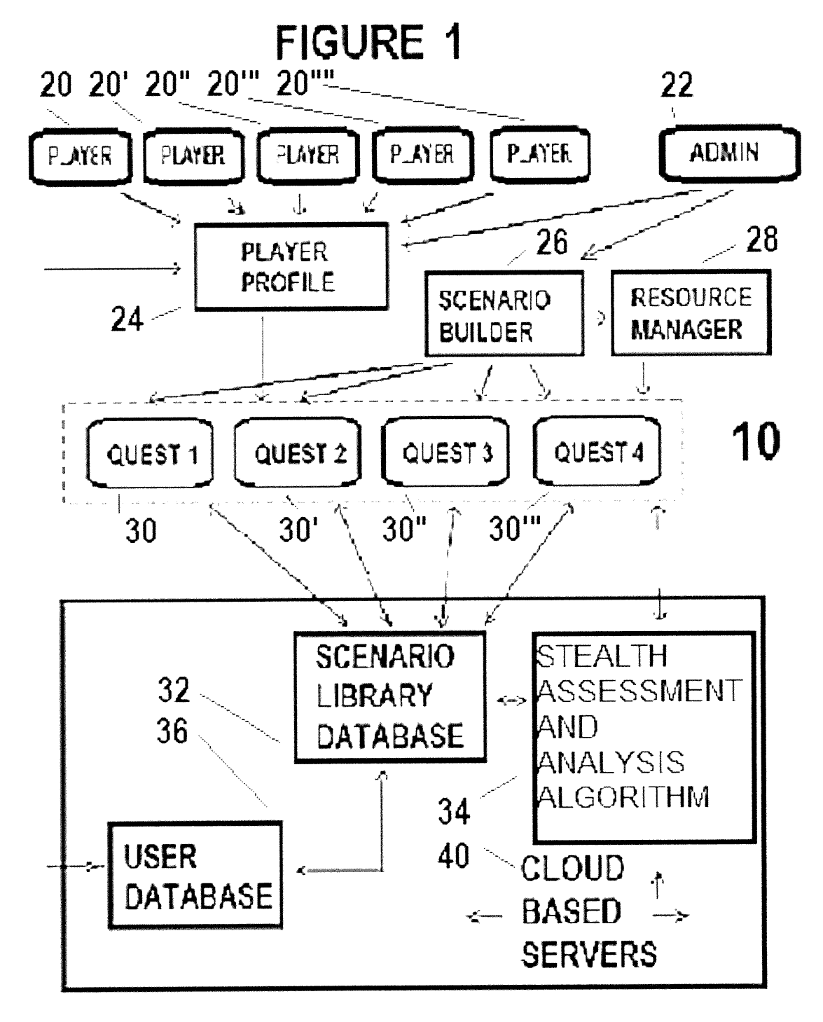

An exemplary, but not exclusive, embodiment of the present invention is shown in FIG. 1. The figure illustrates the overall design and logistical function of the invention herein. A virtual interactive multiplayer platform 10 (“virtual platform”) is provided. The virtual platform 10 is generally configured, compiled and parsed by a server or servers.

For purposes of this application, it is to be understood that the following terms are defined as follows: The term “System Administrator” (22) is defined as a party or entity providing the virtual platform 10 and at least one game scenario for players to work through, using any or a combination of mobile or non-mobile electronic devices such as a laptop or tablet, iPad, smart phone, glass technology, through an interface to at least one player, or other suitable technology, The term “player” is defined as a party or parties who interact using any interface with the virtual platform 10 and scenarios) loaded by the system administrator 22. Any interface discussed herein such as, for example, a player interface is to he defined as any technology and/or device that allows interaction with other servers, devices and/or technologies as discussed herein. These can include, for a few examples, a laptop or PC computer, mobile, ipad, tablet, google glass, virtual reality devices or any suitable technology: though it is to be understood that these examples are representative only and not limiting.

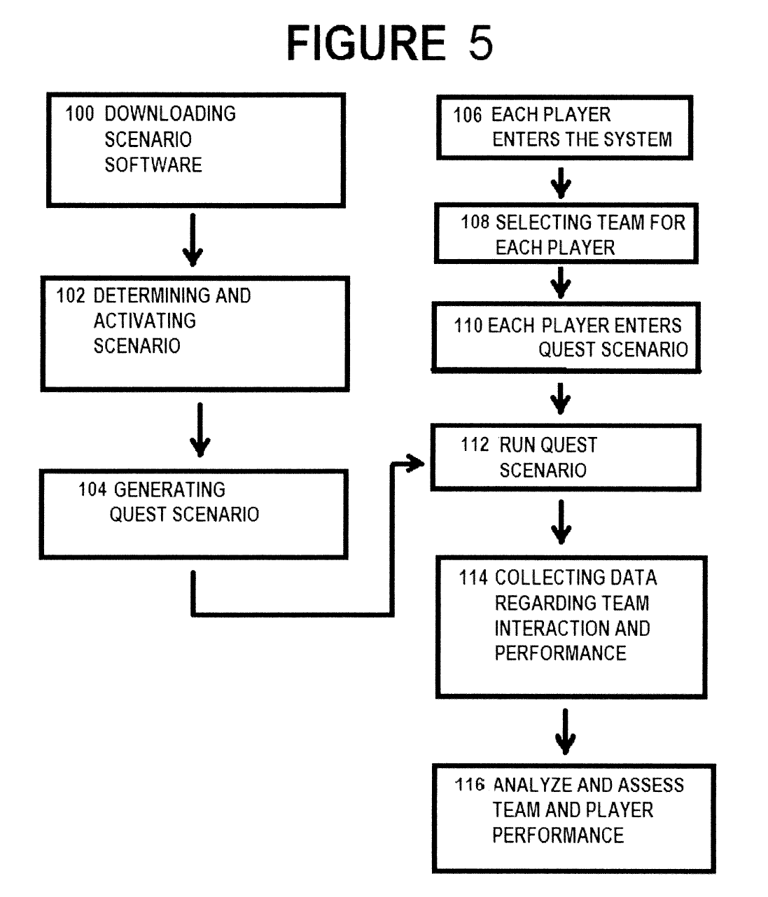

At least one administrator 22, using at least one server or other suitable electronic device, uploads at least one predesigned and programmed scenario through a scenario builder interface 24. The system administrator 22 information is received by the resource manager 28. Then the resource manager 28 populates guest 30 30′ 30″ 30′″ 30″″ and player profile 24 for each is uploaded. One or more users or players (“players”), denoted here as representative 20, 20′, 20″, 20′″, 20″″ enter the virtual platform 10. Though four players are designated herein, this number is for simple representational clarity. It is to be understood that there can be virtually any suitable number of players, depending upon factors such as available access to the system by players and system limitations and capacity. The number of players can be any from one, to hundreds, thousands or more. The players 20, 20′, 20″, 20′″, 20″″ may log into the virtual platform 10 using personal or centralized electronic devices, via individualized interfaces and through a player profile interface 24 The interactive player profile interface 24 accepts information from each player, 20, 20′, 20″, 20′″, 20″″ which the player inputs as will be shown herein. From player profile 24 players are assigned (FIG. 5) by cloud based algorithms 40 to begin quest 10.

A number of specific quests 30, 30′, 30″, 30′″ or challenges, that players can choose, or be assigned, and embark upon are created through the scenario builder interface 26. As with the number of players, the four quests 30, 30′, 30″, 30′″ are representative and limited, in number for clarity, though the number factual scenarios or quests can be virtually any number the virtual platform 10 and underlying server system can support.

The players 20, 20′, 20″, 20′″, 20″″ register and then log in through the player profile interface 24. At the player profile interface 24, players 20, 20′, 20″, 20′″, 20″″ create a virtual avatar for themselves and accept a role within the virtual platform 10. The role and avatar can also be assigned by another party, such as an instructor or administrator 22. The player can be given the option of choosing a level of play, such as, e.g., easy, medium, or difficult. Depending on the type of game being played, a level may be assigned by system administrator 22.

Upon entering the virtual platform 10, each player can choose or be assigned a quest 30, 30′, 30″, 30′″ players 20, 20′, 20″, 20′″, 20″″ can be assigned to a team by the cloud based server 40, administrator 22 choose a team for themselves or choose to interact with a pre-designed and programmed simulated team provided to the players 20, 20′, 20″, 20′″, 20″″ by the cloud based server 40. Assignments can be made according to player interest, profession, grade level, need for continuing professional development and/or other pre-determined factors.

The virtual platform 10, challenges and possible scenarios based upon possible, player actions are loaded into the quests 30, 30′, 30″, 30′″ from the scenario library database 32. Information from this database is loaded into the quests to increase their accuracy, while information from the quests is downloaded into the scenario library database to increase its available information about game play and scenarios from player interaction.

Within each individual quest, the player or team of players 20, 20′, 20″, 20′″, 20″″ faces a specific pre-programmed scenario. The scenario in this embodiment simulates a health situation or emergency calling for inter-professional action and/or treatment. For example, situations from a single complicated patient situation to the wreck of a plane, can be simulated, upon which a group of professionals would be expected to interact to respond to this quest challenge, each bringing his or her specialized education or skills. The players 20, 20′, 20″, 20′″, 20″″ would also be expected to work as a team to resolve the situation and treat any patient(s).

Information about player performance and decisions is tracked routinely from the quests 30, 30′, 30″, 30′″ by the cloud based server 40 usually while in progress, to a stealth assessment and analysis algorithm 34. This information can be further transferred through the database 32 and stored in user database 36 where it may be used to modify or change, based upon pre-determined directions, the quest the player is involved in. The data retrieved from the stealth assessment and analysis interface 34 can measure player competency at such matters as information retention, informal learning, inter-professional education, communication, ethics or other chosen factors, outcomes, lessons and reflection activities, and apply this information to resources given to the players 20, 20′, 20″, 20″″. Players who do not engage in good team work, or who seek advantage by maneuvering or outright cheating will be provided with negative feedback to the stealth assessment and analysis interface 34 and rather than profit from this lack or teamwork and/or ethics, will face reduced resources and a concurrently lowered assessment.

Information about the operation and performance of the players 20, 20′, 20″20′″, 20″″ through the quests 30, 30′, 30″, 30′″ can be collected by a user database 36. By this arrangement, feedback can be collected from the quests 30, 30′, 30″, 30′″ and provided to the player database 36 and to individual players and to the quest administrator 22. Conversely, information about a player from the player profile interface 24 can be transmitted, through the player database 36 and cloud based servers 40 to make decisions such as team and resource allocation for the players. The information can be distributed via at least one server, in this embodiment one or more cloud servers 40 or other real time data storage and dissemination systems known in the art to provide instant feedback to players or other parties on their learning accomplishments.

Turning quickly to FIG. 5, the general steps of the method herein are illustrated: downloading scenario software, determining a scenario and activating it, generating a quest scenario, entry of the system by each player, selecting a team for each entered player, entry of each player into the quest scenario itself, running the virtual interactive quest scenario, collecting data regarding player and team interaction and performance and assessing team and player performance.

This system and method meet a number of challenges to providing effective virtual interactive education to professionals. This use of games and inter-professional simulations can engage students and learners by providing them with scenarios that are digitally enhanced and can increase their understanding of new concepts in their chosen field. With greatly decreased cost and resources as compared to creating and running live simulations, this team-based inter-professional educational system can be used, at a fraction of the cost, for a number of educational opportunities. This can be used to promote cooperative work atmospheres and individualized training for K-12, graduate and professional students, and adult learners. The system can also improve innovation among player and may lower educational costs as the system and method promote not only performance, but reflection and benchmarking, both of which have been shown to improve outcomes in various areas of education.

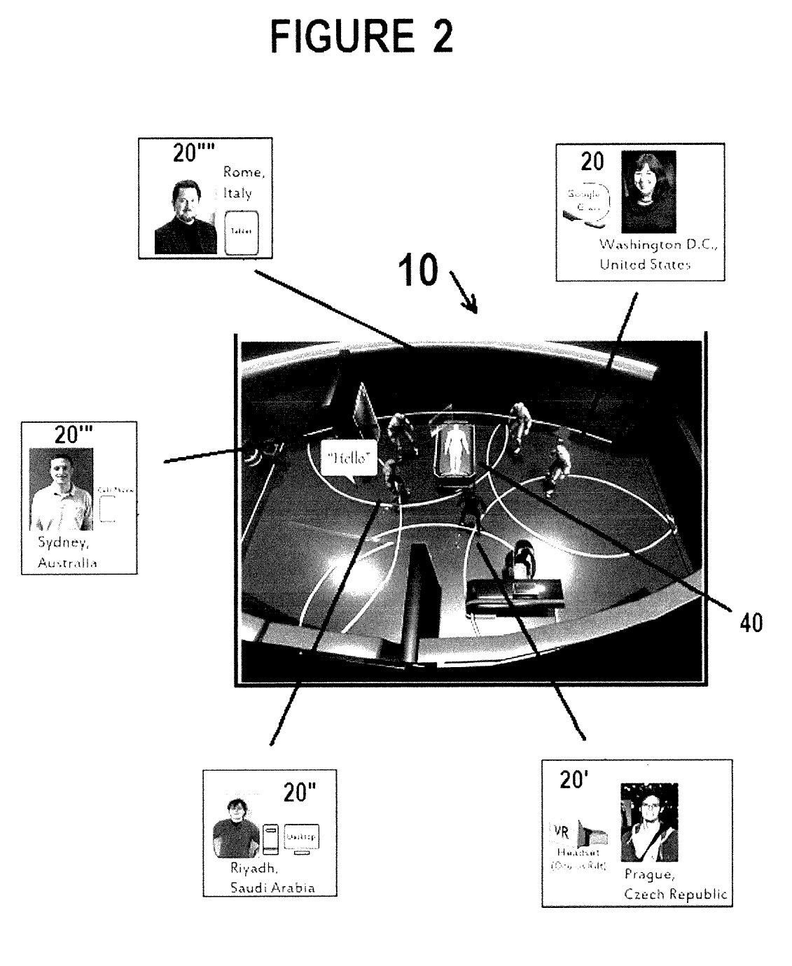

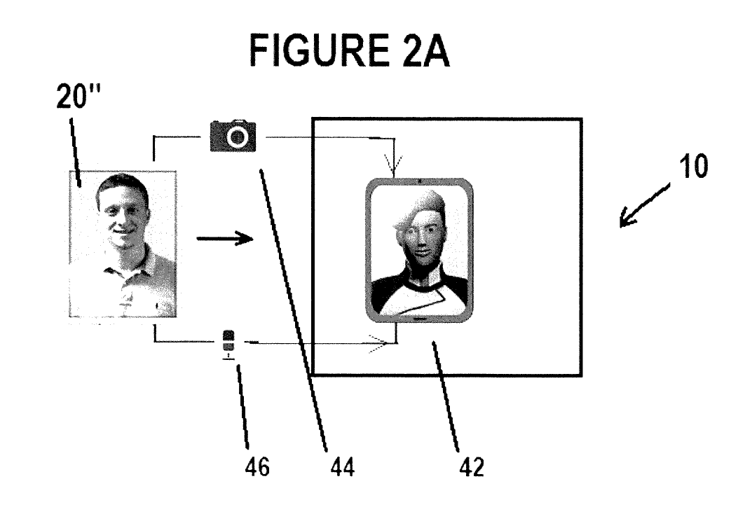

This virtual platform 10 and the games and scenarios provided upon it further address the issue of limited time windows for team play. Using the virtual platform 10, students and learners can have access to this form of inter-professional education literally 24 hours per day. This more effectively meets the needs of the learners and of medical and health care educators. Turning to FIG. 2, features of the design of the team based interaction provided by the virtual platform 10 are shown in further detail. The five representative players 20, 20′, 20″, 20′″ 20″″are shown interacting within the virtual platform 10. The players can, as stated herein, individually use any suitable technology or device, such as, e.g., tablet technology, phone, PC technology, glasses, or virtual simulation device to interact within the virtual environment of the game and with other players on an assigned team or, when suitable, with non-player artificial intelligence (AI) characters in the game. The AI characters are pre-determined, pre-programmed and can be added to the scenario. The characters can be substituted for other team players or provide other roles. Here, an AI character is in the role of virtual patient 41, awaiting treatment by the team of players 20, 20′, 20″, 20″, 20′″ 20″″.

The representational players 20, 20′, 20″, 20′″ 20″″, as shown, can access the virtual platform 10 from any location technology allows, so that traditional geographic constraints are eliminated. In the figure, the players 20, 20′, 20″, 20′″ 20″″ are, as but one example, entering the virtual platform 10 from physical locations in five countries across four continents.

Each player 20, 20′, 20″, 20′″ 20″″ is represented within the virtual platform 10 by a representational avatar. The players 20, 20′, 20″, 20′″ 20″″ can select an avatar from a menu during the log in process. Alternatively, as shown in FIG. 2A, if player devices are equipped with a camera 44, avatar technology known in the art can be used to create a personal avatar 42 of each player, having the facial features of the player based on a photograph taken at log in. In this figure, a sample representative avatar 42 is shown for player 20″. The representative avatar 42 operates on behalf of the player 20″ and can, if the player 20″ continues to use a camera, mimic the facial expressions of each player 20″ to add an additional dimension of realism to the game. Body language (movements and gestures), proxemic principles (personal space), kinesic principles of neck, arm, leg, and finger movements and physiognomy information (facial features and expressions) can be, if cameras are used by the player 20″ in a suitable manner, imitated by the avatar 42 within the virtual platform 10 as it proceeds with quest scenarios or other games.

Referring to FIG. 2 and specifically to FIG. 2A, a communication input or inputs 46 from each of the players 20, 20′, 20″, 20′″ 20″″ such as, for example, talk and/or text, can be processed and transmitted by the virtual platform 10, resulting in live text and speech functions that allow the players 20, 20′, 20″, 20′″ 20″″ to interact with each other in real time during quest scenarios and other types of game play.

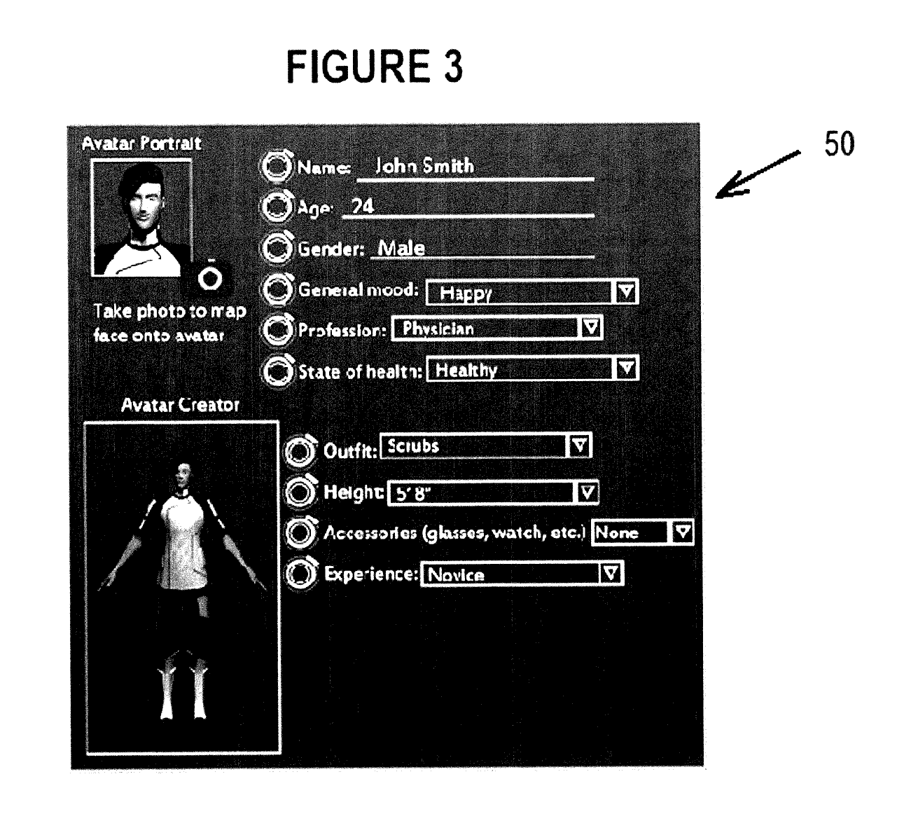

Turning to FIG. 3, a sample player profile screen 50 for the sample player interface 24 featuring sample displayed visual information and data is shown. Information for each player entering the virtual platform 10 is typically entered at the profile Screen 50 as part of the player profile interface 24, by the player or other suitable party such as a professor or supervisor. Information can he entered for each of the players 20, 20′, 20″, 20′″ such as, e.g., general mood, health, profession (if applicable) to which he/she belongs, or, if the player is a k-12 student, grade level. A course administrator or instructor) can add additional fields for course creation and to enroll students into specific quest scenarios within the platform 10.

In addition, screen capture can takes place at the log in screen 50 for the avatar facial features of each of the players 20, 20′, 20″, 20′″, 20″″. The players 20, 20′, 20′″, 20″″, will typically be able to create the look of their avatar and update that look depending on rank and achievement in the game.

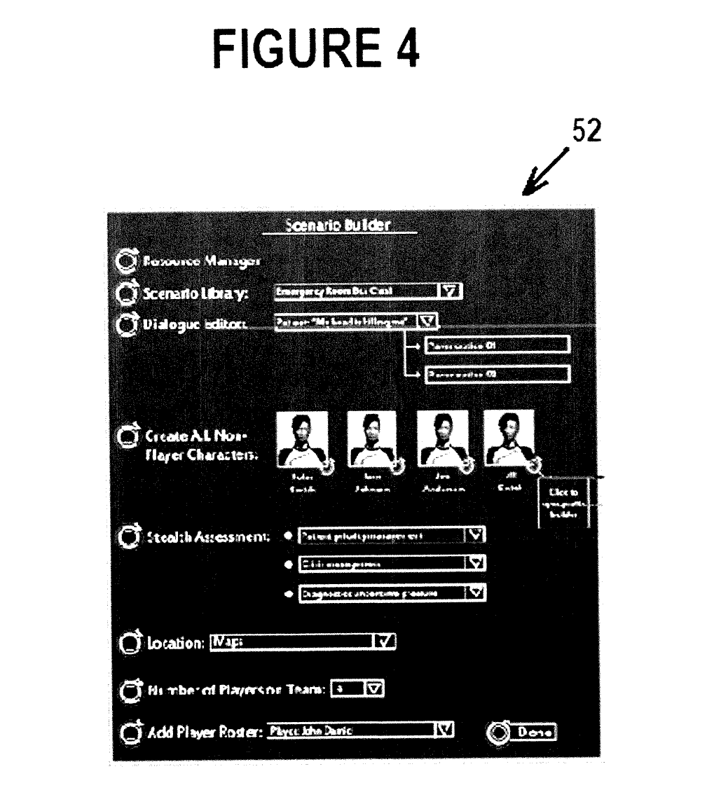

FIG. 4 depicts a sample screen 52 for the scenario builder 26 within the virtual platform that will allow the administrator 22 or other suitable party to create the type of learning environment and more specifically, the quest(s) 30, 30′, 30″, 30′″, desired for each learner. The administrator can also create non player (AI) characters to interact with the team or individual(s) by entering preferences on the scenario builder screen 52. From the scenario builder screen 52, the administrator 22 will also be able to create assessment tools and criteria, and link those to the resource manager 28 that will be used by the player(s) in the virtual platform 10.

Though the number of team members using the virtual platform 10 can be any suitable number, the present embodiment has up to sixteen players representing up to 16 different possible health professions.

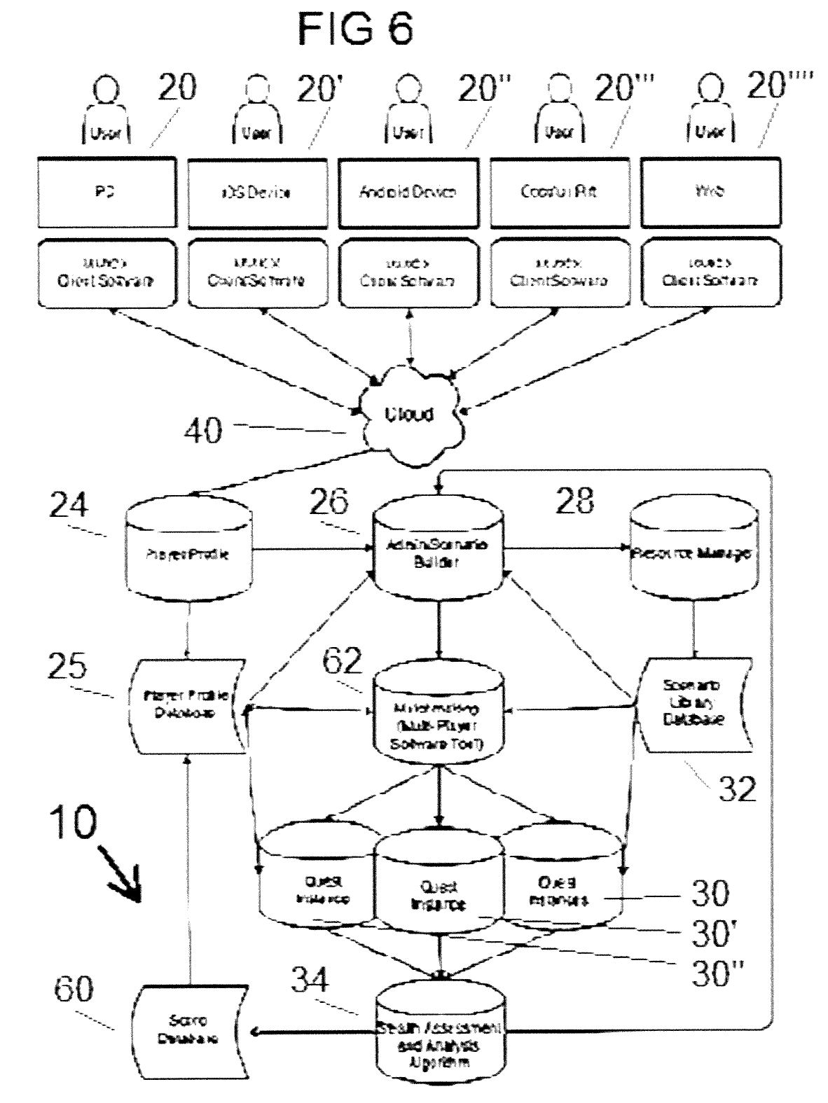

Turning to FIG. 6, a schematic diagram demonstrating yet another embodiment of the present invention, depicting a cloud server 40 and game content distribution, is shown. It is to be understood that a number of alterations of the layout and relationship of components of the multiplayer interactive virtual platform 10 can be either made or depicted without departing from the inventive concept. In this embodiment, a player database 25, that received data from the player profile interface 24 and score database 20, compiling player information, is shown. The role of the cloud server(s) as the interactive locus between the players 20, 20′, 20″, 20′″, and 20″″ and all the game components is also shown. Further, a score database 60 that compiles player performance information and multiplayer software matchmaking tool 62 are depicted. The matchmaking tool 62 receives input data from the player profile database 25, the scenario builder 26, and scenario library database 32, and provides output data to the quests 30, 30′, 30″.

It is to be understood that while a health professions training scenario is depicted in the previous embodiment, this is for illustration purposes. it is contemplated that the multiplayer interactive virtual platform 10 herein can be used for any of a suitable number of applications wherein a team at people with diverse skill sets are or may be required to work together to complete a piece of work. A few further examples to illustrate this point are provided,

In a further embodiment, corporate training scenarios are provided that allows individuals from seemingly disparate divisions in a company to come together in the multiplayer interactive virtual platform 10. The team members can virtually collaborate and train to work through corporate issues, such as creating and sharing client acquisition strategies, sales and marketing, solutions. HR hiring issue solutions, and resolutions of work productivity drop-offs.

In another embodiment, military and/or diplomatic training scenarios are provided that allows individuals from different military and/or diplomatic offices to come together in the multiplayer interactive virtual platform 10. The team members can virtually and train to work through cultural sensitivity issues, negotiation scenario enactment, and conflict resolution.

In another embodiment, military training scenarios are provided that allows individuals from different military offices to come together in the multiplayer interactive virtual platform 10 The team members can virtually collaborate and train to work through issues in security, tactics, strategy, and negotiation.

In another embodiment, 2 team-based and project-based learning scenarios are provided that allows children, through safe avatar representation in the virtual environment of the multiplayer interactive virtual platform 10. Students collaborate and work through virtual scenarios that enhance critical thinking skills and problem solving. Real-time feedback of assessment data and analysis of performance can be included in any or all of these scenarios. For example, data can be collected about students' progress towards learning outcomes. This data can then be made available to any appropriate interested party, such as a parent, teacher, school administrator, or counselor to help the students.

By this invention, a virtual platform and method for use is provided for serious educational games that offer the ability for each player on a team, to interact, communicate, and collaborate simultaneously. Players can work collaboratively to communicate, plan, exchange ideas, and discuss options for achieving the best possible outcome through a scenario in a safe, constructive, convenient work environment. Good performance can be incentivized with associated points and rewards, while areas needing improvement by any player can be identified and addressed. The virtual platform 10 not only has utility for health professions students, but to the K-12 and continuing professional development learner. Faculty and students can review steps to learning, communication and interactions in the team environment in order to provide the student with important insight into their learning.

In addition to students, faculty and leaders in health professions education such as medicine, pharmacy, nursing, public health, social work, and dentistry, the process and method of the virtual platform 10 herein can be used by other professional education categories as well, such as engineering, law, and business. It can also be used by commercial interests for employee training.

By this invention, an interactive virtual platform is provided that can incorporate interprofessional education, problem-based learning and/or team based learning and stealth assessment into a formal or informal learning 24/7 environment for K-12, graduate and professional education, continuing professional development for health care professionals, with assessment, feedback, and benchmark comparison applications, along with social network function.

It is to be understood that while certain forms of the present invention have been illustrated and described, herein, the expression of these individual embodiments is for illustrative purposes and should not be seen as a limitation upon the scope of the invention. It is to be further understood that the invention is not to he limited to the specific forms or arrangements of parts described and shown.

1. A method for using a virtual interactive multiplayer platform, comprising the steps
uploading or downloading pre-programmed scenario software capable of providing at least one virtual scenario,
wherein the scenario software is uploaded or downloaded into or from at least one server or other electronic device,
selecting at least one virtual scenario created from scenario software and generating a virtual a pre-programmed play platform and quest scenario based upon the selected scenario software,
creating a virtual representational avatar for the at least one player to provide a virtual representation of the player within the virtual platform,
providing virtual entry into the virtual platform with the avatar of the at least one player into a scenario,
assigning the at least one player to a virtual interactive team, wherein the team is comprised of either:
at least one other player also represented by a virtual avatar, or
a pre-designed and programmed simulated team selected and provided to the
at least one players by at least one server,
interacting with, and playing out of the pre-programmed scenario by the at least one player,
wherein the at least one player interacts with the least one additional player while playing out the scenario,
providing at least one communication input from the at least one player into the platform so that the at least one player is capable of communication with the at least on other player, and
collecting data regarding at least one aspect of the performance or interaction of the least one player during engagement with the pre-programmed scenario.

2. A method according to claim 1, wherein the functions of the platform are carried out by at least one cloud server.

3. A method according to claim 1, wherein the at least one scenario is created at least partly from data provided by a scenario builder interface.

4. A method according to claim 1, comprising the further step of:
providing an assessment of the performance of the at least one player.

5. A method according to claim 1, wherein the pre-programmed scenario software is comprised of at least two pre-programmed scenarios, and comprising the additional step of:
uploading the at least a portion of the at least two pre-programmed scenarios to at least one server through a scenario builder interface.

6. A method according to claim 1, wherein the at least one player selects a pre-programmed scenario to play or is assigned one by a cloud-based server.

7. A method according to claim 1, comprising the additional step of:
logging the at least one player into the virtual platform through an interface, wherein the at least one player inputs at least one piece of information into the interface.

8. A method according to claim 1, comprising the additional steps of
providing a player profile interface, and
registering and logging in the at least one player through the player profile interface and
assigning a representational avatar to the at least one player.

9. A method according to claim 1, wherein the virtual platform is used for elementary, middle or high school education and comprising the further steps of
collecting progress data regarding at least one learning outcome for at least one student and
placing the data in a review reviewable format, wherein the data is reviewable by an interested parent, teacher, school administrator, or counselor.

10. A method according to claim 1, comprising the further step of:
selecting one of at least three levels of play for the at least one player,
wherein the level of play is either selected by the at least one player or is assigned by either the server or another party.

11. A method according to claim 11, wherein the selection is made based on player interest, player profession, player grade level, player need for continuing professional development, or any combination thereof.

12. A method according to claim 1, comprising the additional step of:
providing a log-in for the at least one player,
wherein the virtual representational avatar for the at least one player is provided during the log in, and is either
based on a photograph of the at least one player, or is selected from a menu of avatars.

13. A method according to claim 1, comprising the additional step of:
directing at least one camera towards the at least one play
feeding data from the at least one camera into at least one server, and
using the date to impose one or more facial movement, one or more bodily movements, or both, onto the avatar to more realistically virtually reflect the at least one player.

14. A method according to claim 1, further comprising the step of:
providing a microphone to the at least one player capable of transmitting voice data to the server,
wherein the at least one playas is capable of voice communication with the at least one other player, or
providing a textual input to the at least one player capable of transmitting textual data to the server, and wherein the at least one player is capable of text communication with the at least one other player, or both.

15. A method according to claim 1, comprising the additional steps of:
loading scenario software from a scenario library database onto the virtual platform, and
loading information from player play into the scenario library, database to increase the available information about play and the at least one player interaction with the at least one other player.

16. A method according to claim 1, comprising the further step of:
monitoring information about player performance and decisions,
transmitting said information to a stealth assessment and analysis algorithm, and
transmitting the information to a user database.

17. A method according to claim 11, further comprising the steps of:
using the transmitted information to modify or change the scenario of the at least one player based upon pre-determined directions.

18. A method according to claim 11, further comprising the steps of:
retrieving the data from the stealth assessment and analysis interface, and
using the data to measure player competency regarding at least one skill or ability.

19. A method according to claim 1, further comprising the steps of:
collecting information about the operation and performance of the at least on player by a user database, and
providing feedback to the at least one player individual player, at least one administrator, or both,
wherein the feedback is provided in real time.

20. A method according to claim 1, wherein the virtual platform is capable of providing educational scenarios for the training of health professionals, corporate, business, marketing or human resources personnel, the military or diplomatic corps, K-12 students university students, medicine, pharmacy, nursing, public health, social work, or dentistry, and
wherein the scenarios are inter-professional, team-based, or both.
